(19) United States
(12) Patent Application Publication
(10) Pub. No.: US 2009/0019721 A1
(43) Pub. Date: Jan. 22, 2009

(54) METHOD AND APPARATUS FOR DRYING PARTICLES OF BULK MATERIAL

(75) Inventors: Sven Vennewald, Oelde (DE); Anette Griese, Oelde (DE); Franz-Gerd Horster, Oelde (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: W. S. Tyler, Mentor, OH (US)

(21) Appl. No.: 12/174,218

(22) Filed: Jul. 16, 2008

(30) Foreign Application Priority Data
Jul. 17, 2007 (DE) 10 2007 033 629.4

(51) Int. Cl. F26B 17/26

(52) U.S. Cl. 34/368; 34/580; 34/586; 34/164

(57) ABSTRACT

In a method of drying particles of bulk material for subsequent transfer to an analyzer for determining a grain size of the particles, a free-flowing particle stream of particles to be dried is formed to move in a transport direction through a drying zone. As it moves through the drying zone, the particle stream is exposed to an air flow which is generated by a fan and heated by an air heater.

### CROSS-REFERENCES TO RELATED APPLICATIONS

This application claims the priority of German Patent Application, Serial No. 10 2007 033 629.4, filed Jul. 17, 20071, pursuant to 35 U.S.C. 119(a)-(d), the content of which is incorporated herein by reference in its entirety as if fully set forth herein.

### BACKGROUND OF THE INVENTION

The present invention relates to a method and apparatus for drying particles of bulk material.

Nothing in the following discussion of the state of the art is to be construed as an admission of prior art.

Examples of bulk material involved here include gravel, stone chips, and like materials. After being collected, these materials can be used for a wide variety of applications. Typically, particles can be used only when their particle size remains within predefined ranges. After being collected, chunks of these materials are initially comminuted by crushers and then classified according to grain size by a screen. Samples are hereby taken and tested in a laboratory with an analyzer to determine whether their grain size is within the accepted range. As the materials being screened are very moist right after their retrieval or after outdoor storage, the samples have to be dried before being analyzed because particles, in particular those of smaller grain size range, tend to agglomerate, i.e. adhere to one another. In other words, the analysis becomes flawed and may result in claims for damages by the supplier because in a wide variety of cases the grain size must be within a certain range.

Agglomeration can be prevented when drying the particles before undergoing the analysis, i.e. to substantially decrease the moisture content so as to be considered dry. Drying chambers have been used which can be heated up to a temperature of for example about 100° C. The drying time is, however, very long and may last 24 hours for example. This is disadvantageous because the analysis takes place at a much later time than the extraction of a sample from the screening device. Before being able to intervene in the screening operation, a large amount of material has already been processed. As a result, the use of drying chambers has been discarded for situations that require rapid drying.

To address these problems, it has been proposed to introduce the particles to be analyzed in a vessel which is then heated by a gas flame. While this may address the time factor, the drying process is too uneven to be considered for laboratory application.

German Offenlegungsschrift DE 29 21 156 A1 describes a high throughput facility for drying, heating and cooling bulk material. The facility uses a treatment gas which acts on the bulk material supplied to the oscillating conveyor in free fall. Subsequently, bulk material transported by the oscillating conveyor is again exposed to the treatment gas from top to bottom and through the conveyor bottom. As the treatment gas passes through the bulk material, heating or cooling is inadequate. In addition, particles of the bulk material stream that have grain sizes which are smaller than the openings of the conveyor bottom fall through the conveyor bottom. These particles of the particle stream represent waste, rendering the overall process inefficient.

It would therefore be desirable and advantageous to address these prior art problems and to obviate other prior art shortcomings.

### SUMMARY OF THE INVENTION

According to one aspect of the present invention, a method of drying particles of bulk material for subsequent transfer to an analyzer for determining a grain size of the particles includes the steps of forming a free-flowing particle stream of particles to be dried, advancing the particle stream in a transport direction through a drying zone, and exposing the particle stream in the drying zone to an air flow, generated by a fan and heated by an air heater.

The present invention resolves prior art problems by the formation of a free-flowing particle stream which is exposed to a heated air flow as it moves through the drying zone. The air flow, generated by a fan, can be heated by the air heating system to a temperature that enables optimum drying results. The particle stream is exposed to the heated air flow as it advanced through the drying zone so as to have residual moisture which allows a separation of the particles even of those particles in the lower grain size range. The air flow may be divided into several single air flows, whereby each single air flow flows through its dedicated air heater. In this way, an even exposure of the particle stream to heated air is ensured.

According to another feature of the present invention, the heating capacity and thus the temperature of each of the single air flows may be controlled independently from one another. As a result, the temperatures of the single air flows may differ, thereby further optimizing the drying process.

According to another feature of the present invention, the particle stream may advance continuously through the drying zone. This ensures a constant exposure of the particle stream with heated air.

According to another feature of the present invention, dividing the particle stream, in particular of particles in the lower range of the grain size, can be enhanced by causing the particle stream to vibrate. This is easy to implement through proper configuration of the conveyor.

According to another feature of the present invention, a continuous jet of compressed air or an intermittent jet of compressed air at ambient temperature may be directed in transport direction upon the particle stream. In this way, moist particles of smaller grain size are prevented from sticking to the conveyor duct. As a result, all particles of the bulk material, regardless of grain size, can be evenly transported and dried.

According to another aspect of the present invention, an apparatus for drying particles of bulk material includes a feed container for discharge of particles, a conveyor disposed adjacent to the feed container for advancing the particles received from the feed container in a transport direction, an air heating system placed above the conveyor, and a fan in flow communication with the air heating system for generating an air flow.

The feed container is constructed to allow control of throughput per time unit with respect to the particle stream and to attain an even particle stream. The particles may be poured into the feed container by hand using a vessel. Of course, loading by means of a conveyor is conceivable as well. The formation of an even particle stream enables optimum drying results as the conveyor moves the particle stream through the drying zone. Positioning the air heating system above the conveyor enables the air flows to directly act on the particle stream, further contributing to an optimum drying effect. The fan may be positioned at any suitable spot within the apparatus, thereby attaining an overall compact structure. The flow connection between fan and air heating system may be realized in any way known to the artisan, for example by a conduit or hose.

According to another feature of the present invention, the conveyor may be constructed as an oscillating conveyor with a metering duct. The transport speed of the particle stream can then be controlled by changing the frequency of the vibration.

According to another feature of the present invention, a discharge element may be provided downstream of the conveyor in the transport direction to ensure a reliable collection of dried particles. The discharge element may be constructed in many ways so long as it is capable of catching the particle stream in a vessel. The discharge element may simply be a slide movable in a vertical direction, or a swingable flap, or an inclined discharge duct. Configuration of the discharge element in the form of a slide or flap leads to a desired heat accumulation. The discharge element may, however, also be configured as a conveyor which can be linked to the analyzer for determining grain sizes. Analyzers of a type involved here are known in the field as CPA (computer-assisted particle analysis).

According to another feature of the present invention, the air heating system may include a plurality of continuous air heaters arranged behind one another and flowed through by the air stream generated by the fan and then divided in single air streams. The number of continuous air heaters depends on the length of the drying zone. The air heaters may be provided with an electric resistance heating. Moreover, the air heaters are constructed to expose the particle stream continuously to the heated air. Therefore, the outlet of each air heater is configured in the shape of a pyramid or cone, with the outlet ports having a greatest cross section.

According to another feature of the present invention, a control unit may be provided for controlling a heating capacity of the air heaters to thereby control a temperature of the single air flows. As a result, the exiting single air flows may have different temperatures. Suitably, the heating capacity and thus the temperatures of the single air flows may be controlled independently from one another. Suitably, a control circuit is provided for controlling the transport speed of the particle stream, the adjustment of the heating capacity of each air heater, and optionally also the feeding of the bulk material. Providing displays for indicating the temperatures of the single air flows facilitate operation of the apparatus for the operator.

As described above, particles being dried are extracted as samples by a machine for processing bulk material, such as a screening machine. In order to change the setting of the processing machine in dependence on the grain sizes of the particle stream being analyzed later, it is provided to operate the apparatus as evaluation unit and to couple it directly or online with a viewing device of the associated processing machine, or to equip the apparatus with at least one display to indicate for example settings of the processing machine.

According to another feature of the present invention, a compressed air generator interacts with the conveyor and produces a continuous or intermittent jet of compressed air directed at the particle stream that passes by in transport direction. This prevents moist particles, in particular those of lower grain size, to stick to the conveyor element of the conveyor or conveyor duct, which would cause an alteration of the screening line of the material sampling. The compressed air jet provides assistance to the conveyor element of the oscillating conveyor so that a combination of oscillating conveyor and pneumatic conveyor is effectively realized.

According to another feature of the present invention, the conveyor or conveyor duct may have an airtight bottom. Thus, the heated air flow is prevented from flowing through the particle stream, resulting in heat accumulation that further enhances the drying effect.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a perspective view of an apparatus for drying particles of bulk material in accordance with the present invention.

### DETAILED DESCRIPTION OF PREFERRED EMBODIMENTS

The depicted embodiment is to be understood as illustrative of the invention and not as limiting in any way. It should also be understood that the FIGURE is not necessarily to scale and that the embodiment is sometimes illustrated by graphic symbols, phantom lines, diagrammatic representations and fragmentary views. In certain instances, details which are not necessary for an understanding of the present invention or which render other details difficult to perceive may have been omitted.

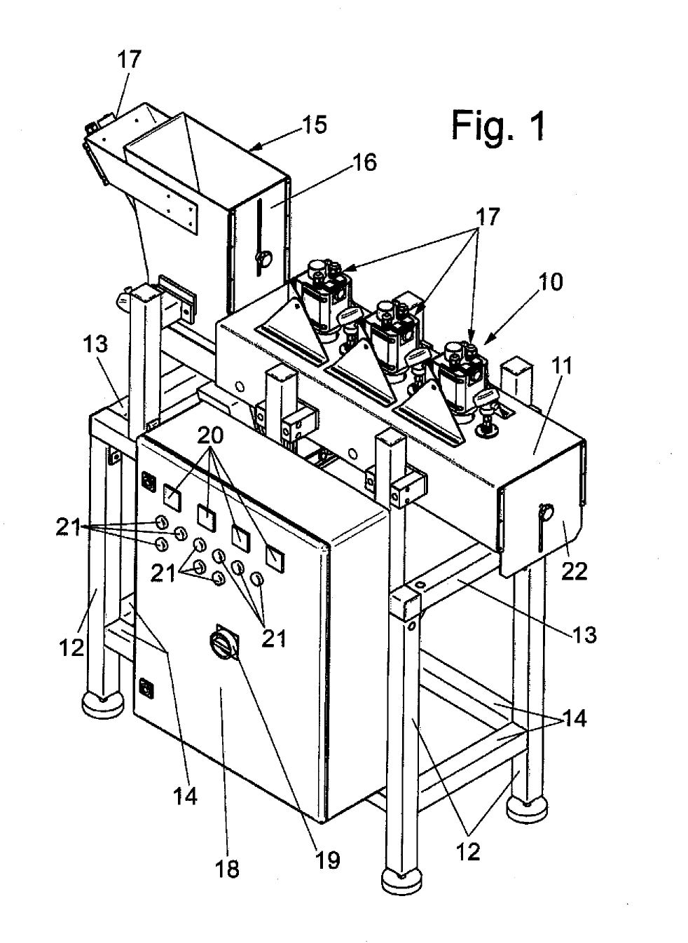

Turning now to FIG. 1, there is shown a perspective view of an apparatus for drying particles of bulk material in accordance with the present invention. The apparatus has a substantially closed housing 11 which accommodates an unillustrated conveyor, for example an oscillating conveyor. The housing 11 is mounted on a stand comprised of vertical columns 12 and upper and lower struts 13, 14 to connect the columns 12. Mounted to one side (left side in FIG. 1) of the stand adjacent to the housing 11 is a feed hopper or feed container 15 positioned upstream the conveyor and provided on its conveyor-proximal side with a slide 16 for adjustment of the volume flow and bed height.

Mounted to a top wall of the housing 11 are a plurality (here three by way of example) continuous air heaters 14 arranged behind one another in movement direction of the conveyor. A further continuous air heater 17 is mounted to the conveyor-distal end of the feed container 15. All air heaters 17 are equipped with an electric resistance heating to heat single air flows flowing through the housing 11 to temperatures between 200 and 300° C. A fan (not shown), e.g. a high pressure fan, is fluidly connected to the air heaters 17 via conduits or hoses. The operating pressure of the fan ranges between 1.3 and 1.5 bar.

Attached to one side of the stand is a cubicle 18 for accommodating the electric and/or electronic components. A main switch 19 is mounted to the outer wall of the cubicle 18 to supply the apparatus with electric energy and to disconnect the apparatus from the power supply. Further integrated in an upper portion of the outer wall of the cubicle 18 are four temperature displays 20 to allow an operator to suitably adjust the temperature of the single air flows. Placed below the temperature displays 20 are control lamps 21 to indicate error messages, malfunctions, and the like, especially with respect to the heating capacity of the air heaters 17 and control of the conveyor. The housing 11 is provided on its side distal to the feed container 15 with a discharge element 22 which is constructed in the non-limiting example shown here in the form of a slide that is movable in a vertical direction. As an alternative, the discharge element 22 may also be constructed in the form of a swingable flap or discharge duct.

In operation, controlled amounts of particles of bulk material are transferred from the feeding container 15 in the form of a particle stream onto the conveyor by which the particles are transported along a drying or heating zone inside the housing 11 to the other end where the particles exit via the discharge element 22 for collection in an unillustrated container for subsequent transfer to an analyzer for determination of a grain size. As the particles advance through the housing, air generated by the fan and passing through the air heaters 17 is heated for heating the particles. The heating capacity of each air heater 17 can hereby be adjusted to the need at hand. In other words, the temperature to which the passing particles are exposed can be individually adjusted by separately controlling the air heaters 17 so that the single air flows released by the air heaters 17 can have different temperatures. During passage of the particles, the conveyor may be acted upon by a continuous or intermittent jet of compressed air which is directed in movement direction of the conveyor upon the particles to prevent any agglomeration of particles.

While the invention has been illustrated and described in connection with currently preferred embodiments shown and described in detail, it is not intended to be limited to the details shown since various modifications and structural changes may be made without departing in any way from the spirit of the present invention The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of drying particles of bulk material for subsequent transfer to an analyzer for determining a grain size of the particles, said method comprising the steps of:
forming a free-flowing particle stream of particles to be dried;
advancing the particle stream in a transport direction through a drying zone; and
exposing the particle stream in the drying zone to an air flow, generated by a fan and heated by an air heater.

2. The method of claim 1, further comprising the step of dividing the air flow into several single air flows for passage through continuous air heaters in one-to-one correspondence.

3. The method of claim 2, further comprising the step of controlling a heating capacity and thus a temperature of each of the single air flows independently from one another.

4. The method of claim 1 wherein the particle stream advances continuously through the drying zone.

5. The method of claim 2, wherein the dividing step includes the step of causing the particle stream to vibrate.

6. The method of claim 5, wherein a lower range of the grain size of the particles is caused to vibrate.

7. The method of claim 1, further comprising the steps of directing a continuous jet of compressed air or an intermittent jet of compressed air at an ambient temperature in transport direction upon the particle stream.

8. Apparatus for drying particles of bulk material, comprising:
a feed container for discharge of particles;
a conveyor disposed adjacent to the feed container for advancing the particles received from the feed container in a transport direction;
an air heating system placed above the conveyor; and
a fan in flow communication with the air heating system for generating an air flow.

9. The apparatus of claim 8, further comprising an analyzer for determining a grain size of the dried particles.

10. The apparatus of claim 8, wherein the conveyor is an oscillating conveyor with a metering duct.

11. The apparatus of claim 8, further comprising a discharge element disposed downstream of the conveyor in the transport direction.

12. The apparatus of claim 11, wherein the discharge element is constructed as a member selected from the group consisting of slide movable in a vertical direction, swingable flap, and discharge duct.

13. The apparatus of claim 8, wherein the air heating system includes a plurality of continuous air heaters arranged behind one another and flowed through by the air stream generated by the fan.

14. The apparatus of claim 13, further comprising means for dividing the air stream, generated by the fan, into single air flows for passage of the air heaters in one-to-one correspondence.

15. The apparatus of claim 14, further comprising a control unit for controlling a heating capacity of the air heaters to thereby control a temperature of the single air flows.

16. The apparatus of claim 15, wherein the control unit is constructed to control the temperature of the single air flows independently from one another.

17. The apparatus of claim 8, wherein the air heating system includes a continuous air heater mounted to an outer side of the feed container.

18. The apparatus of claim 14, further comprising a control circuit for controlling a feeding of the particles, a transport speed of the particle stream, and heating capacity of the air heaters to thereby adjust a temperature of the single air flows.

19. The apparatus of claim 14, further comprising a cubicle provided with temperature displays and turning knobs for adjusting the heating capacity of the air heaters and optional adjustment of the transport speed of the particle stream.

20. The apparatus of claim 8, constructed as evaluation unit in direct connection with a viewing device of an associated processing machine.

21. The apparatus of claim 8, further comprising displays for establishing parameters of an associated processing machine.

22. The apparatus of claim 8, further comprising a compressed air generator interacting with the conveyor and producing a continuous or intermittent jet of compressed air directed at the particle stream advancing in transport direction.

23. The apparatus of claim 8, wherein the conveyor has an airtight bottom.
